(19) United States
(12) Patent Application Publication
(10) Pub. No.: US 2012/0031439 A1
(43) Pub. Date: Feb. 9, 2012

(54) Vehicle Mounted High Pressure Exhaust Duct Cleaning System

(76) Inventors: Gary Richie, Oakdale, MN (US); Anthony Richie, Maplewood, MN (US); Scott Richie, Lake Elmo, MN (US)

(21) Appl. No.: 12/851,411

(22) Filed: Aug. 5, 2010

(51) Int. Cl. B08B 3/00; E03B 5/00; B62D 63/02

(52) U.S. Cl. 134/34; 180/69.6; 137/565.01; 134/198

(57) ABSTRACT

A vehicle mounted high pressure exhaust duct cleaning system is disclosed. The vehicle mounted high pressure exhaust duct cleaning system includes a van-type truck, an internal combustion engine; a fluid reservoir, a high-pressure fluid pump, and a fluid heater. A method of cleaning exhaust ducts is also disclosed.

### BACKGROUND OF THE INVENTION

The use of oils in cooking commonly results in air borne grease and smoke which is commonly vented out of restaurant kitchens with an intake hood and exhaust duct through which the grease and smoke laden air is induced by means of a fan and expelled outside to the ambient atmosphere exterior to the building in which the kitchen is located. This practice is important for sanitary and safety considerations among other factors such as the reduction of offensive odors. If airborne grease is not vented out of the kitchen it will readily result in a conflagration which will readily destroy the kitchen if not the entire building in which the kitchen is located.

The airborne grease, however, in being vented out of the kitchen through a duct, commonly accumulates upon the interior surfaces of the duct walls and creates a fire hazard there, particularly if the duct is connected to an intake hood above a stove which is perhaps the most common arrangement known. In recognition of this fire hazard it is a commonplace in the United States to require periodic degreasing of the interior surfaces of these ducts as a matter of fire code regulation. Restaurants are particularly subject to rather frequent degreasing of their kitchen exhaust ducts because of the large volume of airborne grease carried there through over time and the high rate of grease accumulation resulting there from. Quarterly, monthly, fortnightly and even more frequent periodic degreasings are commonly mandated by state regulations for the interior surfaces of the ducting in many restaurant kitchen ventilation exhaust systems in order to avoid the dangerous fire hazard which would otherwise result.

Current methods of cleaning these exhaust ducts usually involved transporting the equipment, setting up the equipment, look for the appropriate 220 volt electrical outlet, if present, and operating the equipment inside the job site.

What is needed is a vehicle mounted high pressure exhaust cleaning system that overcomes the deficiencies of the small portable electric carts.

### SUMMARY OF THE INVENTION

The present invention provides a vehicle mounted high pressure exhaust duct cleaning system. The vehicle is driven to the job site, typically a commercial kitchen, restaurant, or laboratory, and the system is connected to a water source. High pressure hoses are attached to the vehicle and laid to the interior of the job site. Next, cleaning wands are connected to the outlets of the high pressure hose. The high pressure exhaust duct cleaning system is turned on and a stream of hot, high pressure cleaning solution is directed by an operator into the interior of the exhaust ductwork.

This vehicle mounted high pressure exhaust duct cleaning system offers many advantages of smaller mobile systems that are used inside the job site. First, the large vehicle allows for larger and more powerful cleaning equipment (e.g., engine power source, high pressure pumps, and pressure heaters) to be used that normally could not be delivered inside the job site. Second, the system eliminates the need for very high voltage outlets to be present in the job site in order to power the equipment. Third, the heat, fumes, and noise given off by the larger and more powerful cleaning equipment is not released inside the job site.

The present invention provides a vehicle mounted high pressure exhaust duct cleaning system. The vehicle mounted high pressure exhaust duct cleaning system includes a van-type truck having a rear cargo space bounded at its lower region by a floorboard: an internal combustion engine mounted on the floorboard; a fluid reservoir having an inlet and an outlet and mounted on the floorboard; a high-pressure fluid pump having an inlet and an outlet and mounted on the floorboard, wherein the high-pressure fluid pump is operatively coupled to the internal combustion engine, wherein the inlet of the high-pressure fluid pump is placed in fluid communication with the outlet of the fluid reservoir; and a fluid heater having an inlet and an outlet and mounted in the vehicle, wherein the inlet of the fluid heater is placed in fluid communication with the outlet of the high-pressure fluid pump.

In one embodiment, the vehicle mounted high pressure exhaust duct cleaning system further includes a cleaning wand having an inlet and an outlet, wherein the inlet is placed in fluid communication with the outlet of the fluid heater.

In one embodiment, the vehicle-mounted high pressure exhaust duct cleaning system is used to spray high pressure hot water, steam, or a cleaning solution on an exhaust duct of a cooking hood. In another embodiment, the cleaning solution is a grease dissolving composition. In yet another embodiment, the van-type truck includes a Class 1 truck weighing less than about 6,000 pounds, a Class 2 truck weighing about 6,001 to about 10,000 pounds, a Class 3 truck weighing about 10,001 to about 14,000 pounds, a Class 4 truck weighing about 14,001 to about 16,000 pounds, a Class 5 truck weighing about 16,001 to about 19,500 pounds, or a Class 6 truck weighing about 19,501 to about 26,000 pounds.

In one embodiment, the van-type truck includes a Class 3 truck weighing about 10,001 to about 14,000 pounds. In another embodiment, the internal combustion engine, the fluid reservoir, the high-pressure fluid pump, and the fluid heater are arranged in an orientation that occupies a relatively small area of the total area of the floorboard. In yet another embodiment, the internal combustion engine, and the fluid reservoir are arranged on the first side of the floorboard, and the high-pressure fluid pump and the fluid heater are arranged on the second side of the floorboard thereby creating a walkway on the floorboard for the user to access the rear cargo space.

In one embodiment, the internal combustion engine further includes an exhaust pipe that exits from the rear cargo space to the external atmosphere. In another embodiment, the internal combustion engine includes a spark ignition engine or a compression ignition engine. In yet another embodiment, the spark ignition engine includes a gasoline-powered engine or a propane-powered engine.

In one embodiment, the compression ignition engine includes a diesel-powered engine. In another embodiment, the internal combustion engine includes a rotary engine or a reciprocating engine. In yet another embodiment, the internal combustion engine includes a two-stroke or a four stroke engine.

In one embodiment, the internal combustion engine produces from about 2 horsepower to about 200 horsepower. In another embodiment, the internal combustion engine produces from about 5 horsepower to about 100 horsepower. In yet another embodiment, the internal combustion engine produces from about 15 horsepower to about 40 horsepower.

In one embodiment, the inlet of the fluid reservoir is placed in fluid communication with a fluid source. In another embodiment, the fluid source is a water source. In yet another embodiment, the fluid reservoir includes a fluid level control system.

In one embodiment, the high-pressure fluid pump is a high pressure water pump.

In another embodiment, the high-pressure fluid pump is operated at a pressure from about 50 pounds per square inch to about 15,000 pounds per square inch. In yet another embodiment, the high-pressure fluid pump is operated at a pressure from about 500 pounds per square inch to about 10,000 pounds per square inch. In one embodiment, the high-pressure fluid pump is operated at a pressure from about 2000 pounds per square inch to about 5000 pounds per square inch.

In another embodiment, the fluid heater includes a fluid heating reservoir having an input coupled to the output of the high-pressure fluid pump and a heater for heating the fluid. In yet another embodiment, the fluid heater includes a kerosene-burning heater or a diesel-burning heater.

In one embodiment, the fluid heater is operated at a temperature from about 50 degrees Fahrenheit to about 300 degrees Fahrenheit. In another embodiment, the fluid heater is operated at a temperature from about 100 degrees Fahrenheit to about 250 degrees Fahrenheit. In yet another embodiment, the fluid heater is operated at a temperature from about 175 degrees Fahrenheit to about 225 degrees Fahrenheit.

In one embodiment, the fluid heater produces from about 100,000 British thermal units to about 1,500,000 British thermal units. In another embodiment, the fluid heater produces from about 300,000 British thermal units to about 900,000 British thermal units. In yet another embodiment, the fluid heater produces from about 500,000 British thermal units to about 700,000 British thermal units.

In one embodiment, the fluid heater produces a fluid output from about 2 gallons per minute to about 13 gallons per minute. In another embodiment, the fluid heater produces a fluid output from about 3 gallons per minute to about 10 gallons per minute. In yet another embodiment, the fluid heater produces a fluid output from about 4 gallons per minute to about 8 gallons per minute.

In one embodiment, the fluid heater further includes a temperature sensor for controlling the temperature of the fluid to a desired temperature. In another embodiment, the temperature sensor is in electrical communication with a heater control unit that regulates the heat output of the heater depending upon the output of the temperature sensors. In yet another embodiment, the cleaning wand includes a valve.

In one embodiment, the valve is a hand operated valve. In one embodiment, the vehicle mounted high pressure exhaust duct cleaning system further includes a coupler associated with the outlet of the fluid heater and adapted to connect a hose and the cleaning wand.

In one embodiment, the vehicle mounted high pressure exhaust duct cleaning system further includes a dispenser coupled to the fluid reservoir for adding cleaning fluid to the fluid reservoir.

In one embodiment, the vehicle mounted high pressure exhaust duct cleaning system further includes a system controller operatively coupled to the internal combustion engine, the fluid reservoir, the high-pressure fluid pump, and the fluid heater, wherein the system controller includes a first programmable input and a second programmable input, wherein the system controller is configured: to receive a sensed power output from a power sensor in the internal combustion engine, to receive a sensed fluid level from a fluid level sensor in the fluid reservoir; to receive a sensed fluid pressure level from a fluid pressure sensor in the high-pressure fluid pump, to receive a sensed temperature reading from a temperature sensor in the fluid heater, to output a first control signal to the internal combustion engine for regulating the power output of the internal combustion engine, to output a second control signal to the fluid reservoir for regulating a level of fluid in the fluid reservoir, to output a third control signal to the high-pressure fluid pump for regulating a fluid output of the high-pressure fluid pump, to output a fourth control signal to the fluid heater for regulating a heat output of the fluid heater, wherein the system controller automatically adjusts the first control signal, the second control signal, the third control signal, the fourth control signal, or a combination thereof to maintain a temperature and a fluid output from the fluid heater based upon the programmable input.

The present invention provides a vehicle mounted high pressure exhaust duct cleaning system. The vehicle mounted high pressure exhaust duct cleaning system includes a van-type truck having a rear cargo space bounded at its lower region by a floorboard: an internal combustion engine mounted on the floorboard; a fluid reservoir having an inlet and an outlet and mounted on the floorboard; a high-pressure fluid pump having an inlet and an outlet and mounted on the floorboard, wherein the high-pressure fluid pump is operatively coupled to the internal combustion engine, wherein the inlet of the high-pressure fluid pump is placed in fluid communication with the outlet of the fluid reservoir; a fluid heater having an inlet and an outlet and mounted in the vehicle, wherein the inlet of the fluid heater is placed in fluid communication with the outlet of the high-pressure fluid pump: and a cleaning wand having an inlet and an outlet, wherein the inlet is placed in fluid communication with the outlet of the fluid heater, wherein the vehicle-mounted high pressure exhaust duct cleaning system is used to spray high pressure hot water, steam, or a cleaning solution on an exhaust duct of a cooking hood, wherein the van-type truck includes a Class 3 truck weighing about 10,001 to about 14,000 pounds, wherein the spark ignition engine includes a gasoline-powered engine producing from about 15 horsepower to about 40 horsepower, wherein the high-pressure fluid pump is operated at a pressure from about 2000 pounds per square inch to about 5000 pounds per square inch, wherein the fluid heater includes a kerosene-burning heater operating at a temperature from about 175 degrees Fahrenheit to about 225 degrees Fahrenheit, producing from about 500,000 British thermal units to about 700,000 British thermal units, and producing a fluid output from about 4 gallons per minute to about 8 gallons per minute.

The present invention provides a method of cleaning exhaust ducts. The method includes providing a vehicle mounted high pressure exhaust duct cleaning system including: a van-type truck having a rear cargo space bounded at its lower region by a floorboard: an internal combustion engine mounted on the floorboard; a fluid reservoir having an inlet and an outlet and mounted on the floorboard; a high-pressure fluid pump having an inlet and an outlet and mounted on the floorboard, wherein the high-pressure fluid pump is operatively coupled to the internal combustion engine, wherein the inlet of the high-pressure fluid pump is placed in fluid communication with the outlet of the fluid reservoir; and a fluid heater having an inlet and an outlet and mounted in the vehicle, wherein the inlet of the fluid heater is placed in fluid communication with the outlet of the high-pressure fluid pump; placing in fluid communication the inlet of the fluid reservoir to a fluid source; placing a cleaning wand in fluid communication with the outlet of the fluid heater; placing the cleaning wand in an exhaust duct; and passing a fluid through the cleaning wand.

In one embodiment, the passing the fluid thorough the cleaning wand includes passing a fluid at a pressure from about 50 pounds per square inch to about 15,000 pounds per square inch. In another embodiment, the passing the fluid thorough the cleaning wand includes passing a fluid at a pressure from about 500 pounds per square inch to about 10,000 pounds per square inch. In yet another embodiment, the passing the fluid thorough the cleaning wand includes passing a fluid at a pressure from about 2000 pounds per square inch to about 5000 pounds per square inch.

In one embodiment, the passing the fluid thorough the cleaning wand includes passing a fluid at a temperature from about 50 degrees Fahrenheit to about 300 degrees Fahrenheit. In another embodiment, the passing the fluid thorough the cleaning wand includes passing a fluid at a temperature from about 100 degrees Fahrenheit to about 250 degrees Fahrenheit. In yet another embodiment, the passing the fluid thorough the cleaning wand includes passing a fluid at a fluid output from about 2 gallons per minute to about 13 gallons per minute.

In one embodiment, the passing the fluid thorough the cleaning wand includes passing a fluid at a fluid output from about 3 gallons per minute to about 10 gallons per minute. In another embodiment, the wherein passing the fluid thorough the cleaning wand includes passing a fluid at a fluid output from about 4 gallons per minute to about 8 gallons per minute. In yet another embodiment, the passing the fluid thorough the cleaning wand includes passing a fluid at a pressure from about 2000 pounds per square inch to about 5000 pounds per square inch, at a temperature from about 175 degrees Fahrenheit to about 225 degrees Fahrenheit, and a fluid output from about 4 gallons per minute to about 8 gallons per minute.

In one embodiment, the fluid source is a water source. In another embodiment, the fluid is hot water, steam, or a cleaning solution. In yet another embodiment, the cleaning solution is a grease dissolving composition.

### BRIEF DESCRIPTION OF THE DRAWINGS

Embodiments of the invention may be best understood by referring to the following description and accompanying drawings, which illustrate such embodiments. In the drawings:

FIG. 1 is a top-view drawing illustrating an exemplary vehicle mounted high pressure exhaust duct cleaning system.

FIG. 2 is a side-view drawing illustrating an exemplary vehicle mounted high pressure exhaust duct cleaning system.

FIG. 3 is a rear-view drawing illustrating an exemplary vehicle mounted high pressure exhaust duct cleaning system.

FIG. 4 is a rear-view drawing illustrating an exemplary vehicle mounted high pressure exhaust duct cleaning system.

FIG. 5 is a rear-view drawing illustrating an exemplary vehicle mounted high pressure exhaust duct cleaning system.

FIG. 6 is a block diagram illustrating an exemplary method of using an exemplary vehicle mounted high pressure exhaust duct cleaning system.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides a vehicle mounted high pressure exhaust duct cleaning system. The vehicle is driven to the job site, typically a commercial kitchen, restaurant, or laboratory, and the system is connected to a water source. High pressure hoses are attached to the vehicle and laid to the interior of the job site. Next, cleaning wands are connected to the outlets of the high pressure hose. The high pressure exhaust duct cleaning system is turned on and a stream of hot, high pressure cleaning solution is directed by an operator into the interior of the exhaust ductwork.

This vehicle mounted high pressure exhaust duct cleaning system offers many advantages of smaller mobile systems that are used inside the job site. First, the large vehicle allows for larger and more powerful cleaning equipment (e.g., engine power source, high pressure pumps, and pressure heaters) to be used that normally could not be delivered inside the job site. Second, the system eliminates the need for very high voltage outlets to be present in the job site in order to power the equipment. Third, the heat, fumes, and noise given off by the larger and more powerful cleaning equipment is not released inside the job site.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

The following explanations of certain terms are meant to be illustrative rather than exhaustive. These terms have their ordinary meanings given by usage in the art and in addition include the following explanations.

As used herein, the term “about” refers to a variation of 10 percent of the value specified; for example about 50 percent carries a variation from 45 to 55 percent.

As used herein, the term “and/or” refers to any one of the items, any combination of the items, or all of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to limit the element which they describe, as the various elements may be oriented differently in various applications.

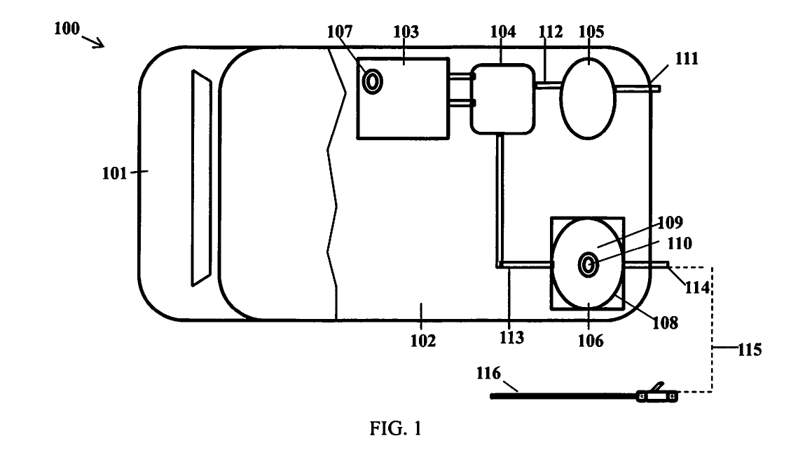

FIG. 1 is a top-view drawing illustrating an exemplary vehicle mounted high pressure exhaust duct cleaning system. The vehicle mounted high pressure exhaust duct cleaning system 100 includes a van-type truck 101 in which is contained a floorboard 102 in the rear section, an internal combustion engine 103 mounted on the floorboard 102, a high pressure fluid pump 104 mounted on the floorboard 102, a fluid reservoir 105 mounted on the floorboard 102, and a fluid heater 106 mounted on the floorboard 102. The high pressure fluid pump 104 is operatively coupled to the internal combustion engine 103. The van-type truck 101 is, preferably, a Class 3 truck weighing about 10,001 to about 14,000 pounds. A suitable van-type truck 101 is a Grumman Olson (Grumman Olson Trucks, Lancaster, Pa., USA) walk-in step van.

The internal combustion engine 103 is, preferably, a gasoline-powered engine that produces from about 15 horsepower to about 40 horsepower. A suitable internal combustion engine 103 is a 27 horsepower Kohler engine (Kohler Engines, Kohler, Wis.). The internal combustion engine 103 is coupled to the exhaust vent 107, which allows the exhaust fumes to exit the van-type truck 101. The internal combustion engine 103 may have its own fuel tank (not shown) or may share the fuel tank of the van-type truck 101 (not shown).

The high-pressure fluid pump 104 is, preferably, operated at a pressure from about 2000 pounds per square inch to about 5000 pounds per square inch. The high-pressure fluid pump 104 may be a positive displacement piston or plunger type pump. A suitable high pressure fluid pump 104 is a Cat Pump (Cat Pumps, Inc., Minneapolis, Minn.). Preferably, the fluid is water. The internal combustion engine 103 drives the high-pressure fluid pump 104 by a pulley on the crankshaft of the internal combustion engine 103 and a v-belt and another pulley on the shaft of the high-pressure fluid pump 104.

The fluid heater 106 includes a lower burner unit 108, a burner shell 109, and an exhaust vent 110. The burner shell 109 has its longitudinal axis in a vertical orientation and contains a helically coiled tube concentric with the shell axis. Fluid flowing inside the coil (not shown) in the burner shell 109 is heated by combustion in the lower burner unit 108 of fuel both atomized and supplied with combustion air in a known manner. The lower burner unit 108 includes a fuel pump and a combustion air blower operated by an electric direct current motor. The pump and blower motor draws electrical power supplied by an alternator on the internal combustion engine 103. The combustion products passing through the burner shell 109 go through the exhaust vent 110 through the roof of the van-type truck 101.

The fluid heater 106 is, preferably, a kerosene-burning heater that is operated at a temperature from about 175 degrees Fahrenheit to about 225 degrees Fahrenheit, produces from about 500,000 British thermal units to about 700,000 British thermal units, and produces a fluid output from about 4 gallons per minute to about 8 gallons per minute. A suitable fluid heater 106 is a cannon kerosene heater. The exhaust vent 110, which allows the exhaust fumes from the fluid heater 106 to exit the van-type truck 101.

A fluid intake conduit 111 connects an external fluid source with the fluid reservoir 105. The fluid reservoir 105 may also contain an automatic shut off valve (not shown) that regulates the fluid level in the fluid reservoir 105. A fluid conduit 112 connects the fluid reservoir 105 and the high-pressure fluid pump 104. A fluid conduit 113 connects the high-pressure fluid pump 104 and the fluid heater 106. A fluid out-take conduit 114 connects the fluid heater 106, the hose 115 and a cleaning wand 116. One or more optional check valves may be inserted in the fluid conduits 111, 112, 113, and 114, as needed to prevent fluid backflow.

One or more unloader valves may also be used as needed in the vehicle mounted high pressure exhaust duct cleaning system. Typically, the unloader valve is placed in fluid communication with the output of the high-pressure fluid pump 104 and causes the output of the high-pressure fluid pump 104 to recirculate to the input of the high-pressure fluid pump 104 when the output of the main pump exceeds a desired value. Further, a pressure sensor may be used in the cleaning wand 116 and operatively connected to the unloader valve.

To operate the exemplary vehicle mounted high pressure exhaust duct cleaning system, the fluid intake conduit 111 is connected to an external fluid source, preferably, a water source. The fluid reservoir 105 is filled up with fluid and the automatic shut off valve (not shown) shuts off the flow of fluid into the fluid reservoir 105. The internal combustion engine 103 is turned on and the high-pressure fluid pump 104 is engaged to transfer fluid from the fluid reservoir 105 to the fluid heater 106 at a desired pressure. The fluid heater 106 is turned on to heat up the fluid in the fluid heater 106 to the desired temperature. After the desired temperature is achieved, the operator directs a stream of high temperature, high pressure fluid at the exhaust duct using the cleaning wand 116. As the cleaning operation proceeds, the fluid level drops in the fluid reservoir 105 and activates the automatic shut off valve to allow fluid to fill the fluid reservoir 105. In turn, more fluid is pumped into the fluid heater 106 to maintain a constant supply of high temperature, high pressure fluid in the fluid heater 106. In this embodiment, the operator manually adjusts the controls on each of the system components, for example, the internal combustion engine 103, the high-pressure fluid pump 104, the fluid reservoir 105, the fluid heater 106, and the cleaning wand 116.

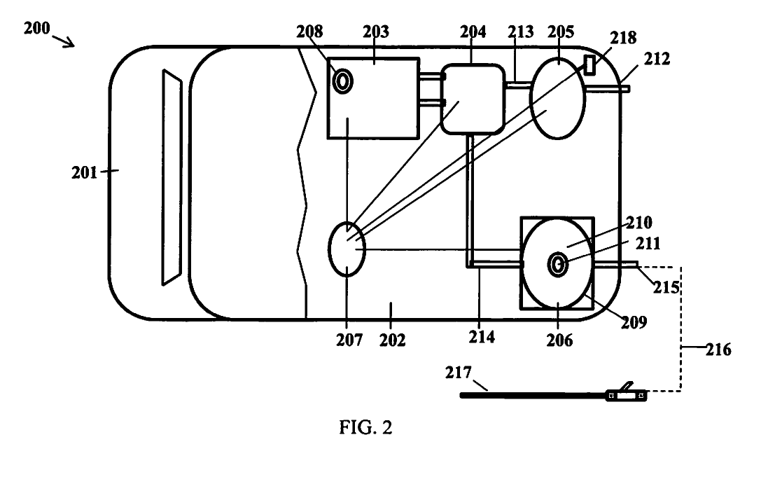

FIG. 2 is a top-view drawing illustrating an exemplary vehicle mounted high pressure exhaust duct cleaning system. The vehicle mounted high pressure exhaust duct cleaning system 200 includes a van-type truck 201 in which is contained a floorboard 202 in the rear section, an internal combustion engine 203 mounted on the floorboard 202, a high pressure fluid pump 204 mounted on the floorboard 202, a fluid reservoir 205 mounted on the floorboard 202, a fluid heater 206 mounted on the floorboard 202, and an optional system controller 207. The high pressure fluid pump 204 is operatively coupled to the internal combustion engine 203. The van-type truck 201 is, preferably, a Class 3 truck weighing about 10,001 to about 14,000 pounds. A suitable van-type truck 201 is a Grumman Olson (Grumman Olson Trucks, Lancaster, Pa., USA) walk-in step van.

The internal combustion engine 203 is, preferably, a gasoline-powered engine that produces from about 15 horsepower to about 40 horsepower. A suitable internal combustion engine 203 is a 27 horsepower Kohler engine (Kohler Engines, Kohler, Wis.). The internal combustion engine 203 is coupled to the exhaust vent 208, which allows the exhaust fumes to exit the van-type truck 201. The internal combustion engine 203 may have its own fuel tank (not shown) or may share the fuel tank of the van-type truck 201 (not shown).

The high-pressure fluid pump 204 is, preferably, operated at a pressure from about 2000 pounds per square inch to about 5000 pounds per square inch. The high-pressure fluid pump 204 may be a positive displacement piston or plunger type pump. A suitable high pressure fluid pump 204 is a Cat Pump (Cat Pumps, Inc., Minneapolis, Minn.). Preferably, the fluid is water. The internal combustion engine 203 drives the high-pressure fluid pump 204 by a pulley on the crankshaft of the internal combustion engine 203 and a v-belt (not shown) and another pulley on the shaft of the high-pressure fluid pump 204.

The fluid heater 206 includes a lower burner unit 209, a burner shell 210, and an exhaust vent 211. The burner shell 210 has its longitudinal axis in a vertical orientation and contains a helically coiled tube concentric with the shell axis. Fluid flowing inside the coil (not shown) in the burner shell 210 is heated by combustion in the lower burner unit 209 of fuel both atomized and supplied with combustion air in a known manner. The lower burner unit 209 includes a fuel pump and a combustion air blower operated by an electric direct current motor. The pump and blower motor draws electrical power supplied by an alternator on the internal combustion engine 203. The alternator can be arranged to charge a lead acid storage battery and the lower burner unit 209 of the fluid heater 206 can be operated from the battery and/or the alternator. The combustion products passing through the burner shell 210 go through the exhaust vent 211 through the roof of the van-type truck 201.

The fluid heater 206 is, preferably, a kerosene-burning heater that is operated at a temperature from about 175 degrees Fahrenheit to about 225 degrees Fahrenheit, produces from about 500,000 British thermal units to about 700,000 British thermal units, and produces a fluid output from about 4 gallons per minute to about 8 gallons per minute. A suitable fluid heater 206 is a cannon kerosene heater. The exhaust vent 211, which allows the exhaust fumes from the fluid heater 206 to exit the van-type truck 201.

A fluid intake conduit 212 connects an external fluid source with the fluid reservoir 205. The fluid reservoir 205 may also contain an automatic shut off valve (not shown) that regulates the fluid level in the fluid reservoir 205. A fluid conduit 213 connects the fluid reservoir 205 and the high-pressure fluid pump 204. A fluid conduit 214 connects the high-pressure fluid pump 204 and the fluid heater 206. A fluid out-take conduit 215 connects the fluid heater 206, the hose 216, and a cleaning wand 217. An optional chemical additive tank 218 is operatively connected to the fluid reservoir 205

The optional system controller 207 is operatively coupled to the internal combustion engine 203, the high-pressure fluid pump 204, fluid reservoir 205, the fluid heater 206, and the optional chemical additive tank 218. One or more optional check valves (not shown) may be inserted in the fluid conduits 212, 213, 214, and 215, as needed to prevent fluid backflow.

One or more unloader valves may also be used as needed in the vehicle mounted high pressure exhaust duct cleaning system. Typically, the unloader valve is placed in fluid communication with the output of the high-pressure fluid pump 204 and causes the output of the high-pressure fluid pump 204 to recirculate to the input of the high-pressure fluid pump 204 when the output of the main pump exceeds a desired value. Further, a pressure sensor may be used in the cleaning wand 217 and operatively connected to the unloader valve.

To operate the exemplary vehicle mounted high pressure exhaust duct cleaning system, the fluid intake conduit 212 is connected to an external fluid source, preferably, a water source. The fluid reservoir 205 is filled up with fluid and the automatic shut off valve (not shown) shuts off the flow of fluid into the fluid reservoir 205. The internal combustion engine 203 is turned on and the high-pressure fluid pump 204 is engaged to transfer fluid from the fluid reservoir 205 to the fluid heater 206 at a desired pressure. The fluid heater 206 is turned on to heat up the fluid in the fluid heater 206 to the desired temperature. After the desired temperature is achieved, the operator directs a stream of high temperature, high pressure fluid at the exhaust duct using the cleaning wand 217. As the cleaning operation proceeds, the fluid level drops in the fluid reservoir 205 and activates the automatic shut off valve to allow fluid to fill the fluid reservoir 205. In turn, more fluid is pumped into the fluid heater 206 to maintain a constant supply of high temperature, high pressure fluid in the fluid heater 206. In this embodiment, the optional system controller 207 automatically adjusts the controls on each of the system components, for example, the internal combustion engine 203, the high-pressure fluid pump 204, the fluid reservoir 205, the fluid heater 206, and the cleaning wand 217.

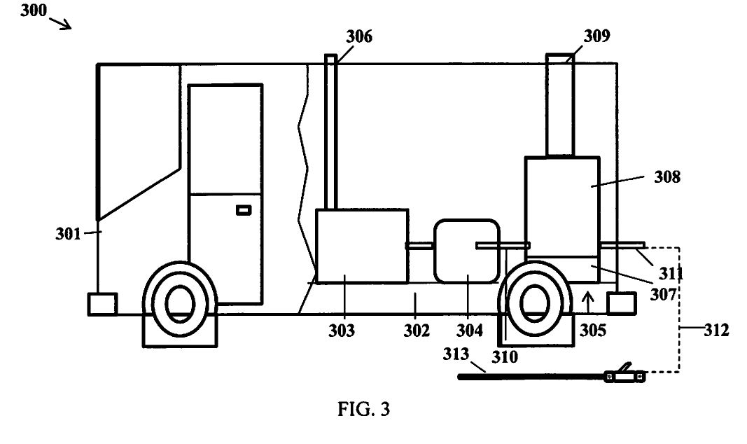

FIG. 3 is a side-view drawing illustrating an exemplary vehicle mounted high pressure exhaust duct cleaning system. The vehicle mounted high pressure exhaust duct cleaning system 300 includes a van-type truck 301 in which is contained a floorboard 302 in the rear section, an internal combustion engine 303 mounted on the floorboard 302, a high pressure fluid pump 304 mounted on the floorboard 302, a fluid reservoir (not shown), and a fluid heater 305 mounted on the floorboard 302. The high pressure fluid pump 304 is operatively coupled to the internal combustion engine 303. The van-type truck 301 is, preferably, a Class 3 truck weighing about 10,001 to about 14,000 pounds. A suitable van-type truck 301 is a Grumman Olson (Grumman Olson Trucks, Lancaster, Pa., USA) walk-in step van.

The internal combustion engine 303 is, preferably, a gasoline-powered engine that produces from about 15 horsepower to about 40 horsepower. A suitable internal combustion engine 303 is a 27 horsepower Kohler engine (Kohler Engines, Kohler, Wis.). The internal combustion engine 303 is coupled to the exhaust vent 306, which allows the exhaust fumes to exit the van-type truck 301. The internal combustion engine 303 may have its own fuel tank (not shown) or may share the fuel tank of the van-type truck 301 (not shown).

The high-pressure fluid pump 304 is, preferably, operated at a pressure from about 3000 pounds per square inch to about 5000 pounds per square inch. The high-pressure fluid pump 304 may be a positive displacement piston or plunger type pump. A suitable high pressure fluid pump 304 is a Cat Pump (Cat Pumps, Inc., Minneapolis, Minn.). Preferably, the fluid is water. The internal combustion engine 303 drives the high-pressure fluid pump 304 by a pulley on the crankshaft of the internal combustion engine 303 and a v-belt and another pulley on the shaft of the high-pressure fluid pump 304.

The fluid heater 305 includes a lower burner unit 307, a burner shell 308, and an exhaust vent 309. The burner shell 308 has its longitudinal axis in a vertical orientation and contains a helically coiled tube concentric with the shell axis. Fluid flowing inside the coil (not shown) in the burner shell 308 is heated by combustion in the lower burner unit 307 of fuel both atomized and supplied with combustion air in a known manner. The lower burner unit 307 includes a fuel pump and a combustion air blower operated by an electric direct current motor. The pump and blower motor draws electrical power supplied by an alternator on the internal combustion engine 303. The alternator can be arranged to charge a lead acid storage battery and the lower burner unit 307 of the fluid heater 305 can be operated from the battery and/or the alternator. The combustion products passing through the burner shell 308 go through the exhaust vent 309 through the roof of the van-type truck 301.

The fluid heater 305 is, preferably, a kerosene-burning heater that is operated at a temperature from about 175 degrees Fahrenheit to about 225 degrees Fahrenheit, produces from about 500,000 British thermal units to about 700,000 British thermal units, and produces a fluid output from about 4 gallons per minute to about 8 gallons per minute. A suitable fluid heater 305 is a cannon kerosene heater. The exhaust vent 309, which allows the exhaust fumes from the fluid heater 305 to exit the van-type truck 301.

A fluid conduit 310 connects the high-pressure fluid pump 304 and the fluid heater 305. A fluid out-take conduit 311 connects the fluid heater 305, a hose 312, and a cleaning wand 313. One or more optional check valves may be inserted in the fluid conduits 310 and 311, as needed to prevent fluid backflow.

One or more unloader valves may also be used as needed in the vehicle mounted high pressure exhaust duct cleaning system. Typically, the unloader valve is placed in fluid communication with the output of the high-pressure fluid pump 304 and causes the output of the high-pressure fluid pump 304 to recirculate to the input of the high-pressure fluid pump 304 when the output of the main pump exceeds a desired value. Further, a pressure sensor may be used in the cleaning wand 313 and operatively connected to the unloader valve.

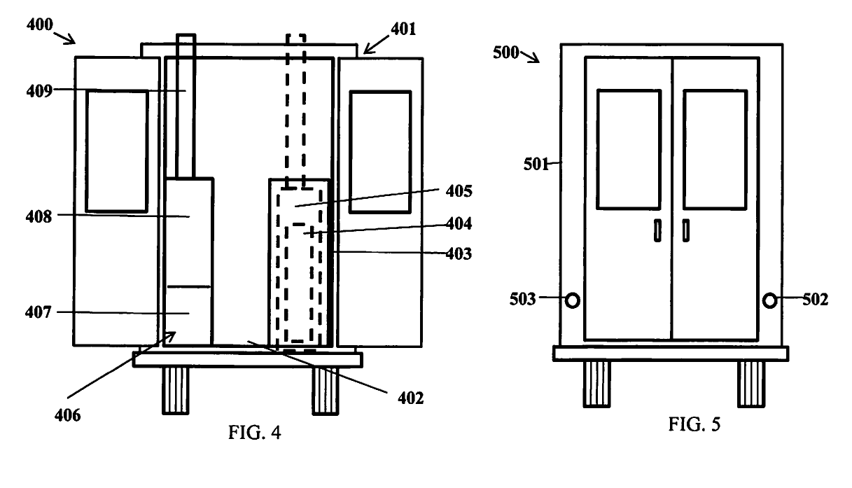

FIG. 4 is a rear-view drawing illustrating an exemplary vehicle mounted high pressure exhaust duct cleaning system. The vehicle mounted high pressure exhaust duct cleaning system 400 includes a van-type truck 401 in which is contained a floorboard 402 in the rear section, a fluid reservoir 403, a high pressure fluid pump 404, an internal combustion engine 405, and a fluid heater 406. The fluid heater 406 includes a lower burner unit 407, a burner shell 408, and an exhaust vent 409.

FIG. 5 is a rear-view drawing illustrating an exemplary vehicle mounted high pressure exhaust duct cleaning system. The vehicle mounted high pressure exhaust duct cleaning system 500 includes a van-type truck 501, a fluid intake conduit 502, which connects an external fluid source with the fluid reservoir (not shown), and a fluid out-take conduit 503, which connects the fluid heater (not shown) and a cleaning wand (not shown).

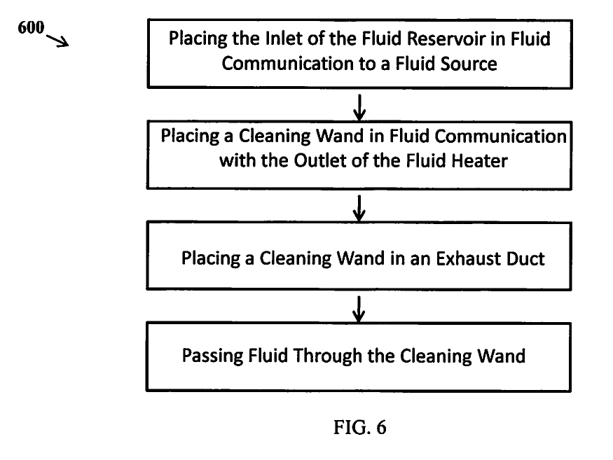

FIG. 6 is a block diagram illustrating an exemplary method 600 of using an exemplary vehicle mounted high pressure exhaust duct cleaning system. The method 600 includes; providing a vehicle mounted high pressure exhaust duct cleaning system including: a van-type truck having a rear cargo space bounded at its lower region by a floorboard: an internal combustion engine mounted on the floorboard; a fluid reservoir having an inlet and an outlet and mounted on the floorboard; a high-pressure fluid pump having an inlet and an outlet and mounted on the floorboard, wherein the high-pressure fluid pump is operatively coupled to the internal combustion engine, wherein the inlet of the high-pressure fluid pump is placed in fluid communication with the outlet of the fluid reservoir; and a fluid heater having an inlet and an outlet and mounted in the vehicle, wherein the inlet of the fluid heater is placed in fluid communication with the outlet of the high-pressure fluid pump; placing in fluid communication the inlet of the fluid reservoir to a fluid source; placing a cleaning wand in fluid communication with the outlet of the fluid heater; placing the cleaning wand in an exhaust duct; and passing a fluid through the cleaning wand.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed then several other steps are performed shall be taken to mean that the first step is performed before any of the other steps, but the other steps may be performed in any sequence unless a sequence is further specified within the other steps. For example, claim elements that recite “first A, then B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention. Applicants reserve the right to physically incorporate into this specification any and all materials and information from any such patents, applications, publications, scientific articles, web sites, electronically available information, and other referenced materials or documents. Applicants reserve the right to physically incorporate into any part of this document, including any part of the written description, the claims referred to above including but not limited to any original claims.

1. A vehicle mounted high pressure exhaust duct cleaning system comprising:
a van-type truck having a rear cargo space bounded at its lower region by a floorboard:
an internal combustion engine mounted on the floorboard;
a fluid reservoir having an inlet and an outlet and mounted on the floorboard;
a high-pressure fluid pump having an inlet and an outlet and mounted on the floorboard,
wherein the high-pressure fluid pump is operatively coupled to the internal combustion engine,
wherein the inlet of the high-pressure fluid pump is placed in fluid communication with the outlet of the fluid reservoir; and
a fluid heater having an inlet and an outlet and mounted in the vehicle,
wherein the inlet of the fluid heater is placed in fluid communication with the outlet of the high-pressure fluid pump,.
wherein the internal combustion engine, and the fluid reservoir are arranged on a first side of the floorboard, and the high-pressure fluid pump and the fluid heater are arranged on a second side of the floorboard thereby creating a walkway on the floorboard for the user to access the rear cargo space.

2. The vehicle mounted high pressure exhaust duct cleaning system of claim 1, further comprising a cleaning wand having an inlet and an outlet, wherein the inlet is placed in fluid communication with the outlet of the fluid heater.

3. The vehicle mounted high pressure exhaust duct cleaning system of claim 1, wherein the vehicle-mounted high pressure exhaust duct cleaning system is used to spray high pressure hot water, steam, or a cleaning solution on an exhaust duct of a cooking hood.

4. The vehicle mounted high pressure exhaust duct cleaning system of claim 1, wherein the van-type truck comprises a Class 3 truck weighing about 10,001 to about 14,000 pounds.

5. The vehicle mounted high pressure exhaust duct cleaning system of claim 1, wherein the internal combustion engine comprises a gasoline-powered engine.

6. The vehicle mounted high pressure exhaust duct cleaning system of claim 1, wherein internal combustion engine produces from about 15 horsepower to about 40 horsepower.

7. The vehicle mounted high pressure exhaust duct cleaning system of claim 1, wherein the inlet of the fluid reservoir is placed in fluid communication with a fluid source.

8. The vehicle mounted high pressure exhaust duct cleaning system of claim 7, wherein the fluid source is a water source.

9. The vehicle mounted high pressure exhaust duct cleaning system of claim 1, wherein the fluid reservoir comprises a fluid level control system.

10. The vehicle mounted high pressure exhaust duct cleaning system of claim 1, wherein the high-pressure fluid pump is operated at a pressure from about 2000 pounds per square inch to about 5000 pounds per square inch.

11. The vehicle mounted high pressure exhaust duct cleaning system of claim 1, wherein the fluid heater comprises a fluid heating reservoir having an input coupled to the output of the high-pressure fluid pump and a heater for heating the fluid.

12. The vehicle mounted high pressure exhaust duct cleaning system of claim 1, wherein the fluid heater comprises a kerosene-burning heater.

13. The vehicle mounted high pressure exhaust duct cleaning system of claim 1, wherein the fluid heater is operated at a temperature from about 175 degrees Fahrenheit to about 225 degrees Fahrenheit.

14. The vehicle mounted high pressure exhaust duct cleaning system of claim 1, wherein the fluid heater produces from about 500,000 British thermal units to about 700,000 British thermal units.

15. The vehicle mounted high pressure exhaust duct cleaning system of claim 1, wherein the fluid heater produces a fluid output from about 4 gallons per minute to about 8 gallons per minute.

16. The vehicle mounted high pressure exhaust duct cleaning system of claim 1, further comprising a system controller operatively coupled to the internal combustion engine, the fluid reservoir, the high-pressure fluid pump, and the fluid heater,
wherein the system controller includes a first programmable input and a second programmable input,
wherein the system controller is configured:
to receive a sensed power output from a power sensor in the internal combustion engine,
to receive a sensed fluid level from a fluid level sensor in the fluid reservoir;
to receive a sensed fluid pressure level from a fluid pressure sensor in the high-pressure fluid pump,
to receive a sensed temperature reading from a temperature sensor in the fluid heater,
to output a first control signal to the internal combustion engine for regulating the power output of the internal combustion engine,
to output a second control signal to the fluid reservoir for regulating a level of fluid in the fluid reservoir,
to output a third control signal to the high-pressure fluid pump for regulating a fluid output of the high-pressure fluid pump,
to output a fourth control signal to the fluid heater for regulating a heat output of the fluid heater,
wherein the system controller automatically adjusts the first control signal, the second control signal, the third control signal, the fourth control signal, or a combination thereof to maintain a temperature and a fluid output from the fluid heater based upon the programmable input.

17. A vehicle mounted high pressure exhaust duct cleaning system comprising:
a van-type truck having a rear cargo space bounded at its lower region by a floorboard:
an internal combustion engine mounted on the floorboard;
a fluid reservoir having an inlet and an outlet and mounted on the floorboard;
a high-pressure fluid pump having an inlet and an outlet and mounted on the floorboard,
wherein the high-pressure fluid pump is operatively coupled to the internal combustion engine,
wherein the inlet of the high-pressure fluid pump is placed in fluid communication with the outlet of the fluid reservoir;
a fluid heater having an inlet and an outlet and mounted in the vehicle,
wherein the inlet of the fluid heater is placed in fluid communication with the outlet of the high-pressure fluid pump: and
a cleaning wand having an inlet and an outlet, wherein the inlet is placed in fluid communication with the outlet of the fluid heater,
wherein the vehicle-mounted high pressure exhaust duct cleaning system is used to spray high pressure hot water, steam, or a cleaning solution on an exhaust duct of a cooking hood,
wherein the van-type truck comprises a Class 3 truck weighing about 10,001 to about 14,000 pounds,
wherein the spark ignition engine comprises a gasoline-powered engine producing from about 15 horsepower to about 40 horsepower,
wherein the high-pressure fluid pump is operated at a pressure from about 2000 pounds per square inch to about 5000 pounds per square inch,
wherein the fluid heater comprises a kerosene-burning heater operating at a temperature from about 175 degrees Fahrenheit to about 225 degrees Fahrenheit, producing from about 500,000 British thermal units to about 700,000 British thermal units, and producing a fluid output from about 4 gallons per minute to about 8 gallons per minute,
wherein the internal combustion engine, and the fluid reservoir are arranged on a first side of the floorboard, and the high-pressure fluid pump and the fluid heater are arranged on a second side of the floorboard thereby creating a walkway on the floorboard for the user to access the rear cargo space.

18. A method of cleaning exhaust ducts comprising
providing a vehicle mounted high pressure exhaust duct cleaning system comprising:
a van-type truck having a rear cargo space bounded at its lower region by a floorboard:
an internal combustion engine mounted on the floorboard;
a fluid reservoir having an inlet and an outlet and mounted on the floorboard;
a high-pressure fluid pump having an inlet and an outlet and mounted on the floorboard,
wherein the high-pressure fluid pump is operatively coupled to the internal combustion engine,
wherein the inlet of the high-pressure fluid pump is placed in fluid communication with the outlet of the fluid reservoir;
a fluid heater having an inlet and an outlet and mounted in the vehicle,
wherein the inlet of the fluid heater is placed in fluid communication with the outlet of the high-pressure fluid pump;
placing in fluid communication the inlet of the fluid reservoir to a fluid source;
placing a cleaning wand in fluid communication with the outlet of the fluid heater;
placing the cleaning wand in an exhaust duct; and
passing a fluid through the cleaning wand.

19. The method of cleaning exhaust ducts of claim 18, wherein passing the fluid thorough the cleaning wand comprises passing a fluid at a pressure from about 2000 pounds per square inch to about 5000 pounds per square inch, at a temperature from about 175 degrees Fahrenheit to about 225 degrees Fahrenheit, and a fluid output from about 4 gallons per minute to about 8 gallons per minute.

20. The method of cleaning exhaust ducts of claim 18, wherein the fluid source is a water source and the fluid is hot water, steam, or a cleaning solution.
